(19) United States
(12) Patent Application Publication
(10) Pub. No.: US 2012/0145471 A1
(43) Pub. Date: Jun. 14, 2012

(54) Pyramid Structure for Non Engine End Frame (NEEF) of a Wheel Loader

(75) Inventors: Xiaoming Tan, Apex, NC (US); Gerald Fuerst, Cary, NC (US)

(73) Assignee: CATERPILLAR, INC., Peoria, IL (US)

(21) Appl. No.: 12/967,907

(22) Filed: Dec. 14, 2010

(51) Int. Cl. E02F 9/00; B21D 53/88; B62D 21/00

(52) U.S. Cl. 180/311; 29/897.2

(57) ABSTRACT

A frame assembly and method for manufacturing such a frame assembly for a vehicle are disclosed. The frame assembly may comprise spaced apart tower walls separated by a middle portion and a foot joined to the tower wall. The foot and the tower wall may define a cavity. The foot may comprise a slanted front member, a rear member disposed opposite to the front member, and a side member. The side member may be disposed between the front and rear members and may be oriented to form an angle α with the first tower wall.

### TECHNICAL FIELD

The present disclosure generally relates to frame assemblies of vehicles used in earth moving, construction and mining applications and, more particularly, relates to the Non Engine End Frame (NEEF) of such vehicles.

### BACKGROUND

The frames of vehicles used for earth moving, construction, material handling and mining are often subject to extremely high loads from multiple sources, especially side forces. For example, when a wheel loader is pushing or digging into a pile of material, forces are exerted against the digging/pushing implement and travel through the lift arms and boom to the NEEF. The side forces generated can be quite severe and may cause torquing of the sidewalls of the frame of the vehicle. This often results in cracking within the NEEF structure as well as cracking in the joint between the NEEF and the axle housing.

Similarly, when a vehicle, such as a wheel loader, is lifting a load or traveling with a load, the combined weight of the lift arms, the boom and the load causes substantial force to travel down the lift arms and torque the frame of the vehicle. The high lateral stress on the sidewalls due to the torquing of the frame can also result in cracking within the NEEF structure as well as in the joint between the NEEF and the axle housing.

In addition, debris from loads or rough terrain often accumulates on top of the axle housing in earth moving, construction, material handling and mining vehicles. Over time, the accumulated debris interferes with the steering and handling of the vehicle. Because of the industrial applications of such vehicles, it is often not feasible for an operator to stop his vehicle to remove such accumulated debris.

U.S. Pat. No. 6,098,870 granted Aug. 8, 2000 (the '870 Patent) is an example of prior art in the area of frame assemblies for construction vehicles. FIGS. 1-2 of the '870 Patent illustrate one embodiment of a manner in which the structural strength of a frame assembly may be improved. FIGS. 1-2 illustrate a frame assembly 16 that is positioned on a front axle housing 17. A gusset 46 is shown joined to the sidewall 32 of the frame assembly 16 and to the axle plate 111. The gusset is secured to the frame assembly to increase its structural strength. While this gusseted frame assembly may perform well in some situations, it may suffer from several disadvantages. For instance, the gussets do not appear to have shedding characteristics and may even assist in unwanted material and debris being trapped in the vehicle wheel area. A design is needed that improves ability of the frame assembly to withstand operating forces, especially side forces, and to shed debris effectively.

### SUMMARY OF THE DISCLOSURE

In accordance with one aspect of the disclosure, a frame assembly for a vehicle is disclosed. The frame assembly comprises first and second spaced apart tower walls separated by a middle portion and a foot joined to the first tower wall. The foot and the first tower wall may define a cavity having a mouth. The foot may comprise a slanted front member, a rear member disposed opposite to the front member, and a side member. The side member may include a substantially vertical tab and an inclined body portion. The tab may be disposed above the inclined body portion and may be joined onto the first tower wall. The side member may be disposed between the front and rear members and may be oriented to form an angle α with the first tower wall.

In accordance with another aspect of the disclosure, a frame assembly is disclosed for a vehicle having an axle. The frame assembly may comprise first and second spaced apart tower walls separated by a middle portion, and a hollow foot joined to the first tower wall. The foot may have a tast factor in the range of about 1.26 to about 4.74. The foot may comprise a slanted front member, a rear member disposed opposite to the front member, and a side member having an inclined body portion. The side member may be disposed between the front and rear members and may be oriented to form an angle α with the first tower wall.

In accordance with a further aspect of the disclosure, a method of manufacturing a frame assembly for a vehicle is disclosed. The method may comprise forming a foot comprising a slanted front member fixedly joined to a side member having an inclined body portion, providing a tower assembly that include first and second spaced apart tower walls separated by a middle portion, positioning the foot against the first tower wall to define a cavity between the tower wall and the foot, and fixedly securing the foot to the first tower wall so that the inclined body portion substantially forms an angle α in the range of about 15° to about 45° and the slanted front member generally follows the contour of a sloped leading front edge of the first tower wall.

### BRIEF DESCRIPTION OF THE DRAWINGS

FIG. 1 is a perspective view of a frame assembly constructed in accordance with the teachings of this disclosure;

FIG. 2 is a perspective view of a machine which incorporates the features of the present disclosure;

FIG. 3 is cross-sectional view of the foot of the frame assembly of FIG. 1;

FIG. 4 is an enlarged perspective view of foot of the frame assembly of FIG. 1 mounted on a fender attached to an axle pad; and

FIG. 5 is an enlarged front view of a portion of the frame assembly of FIG. 1.

### DETAILED DESCRIPTION

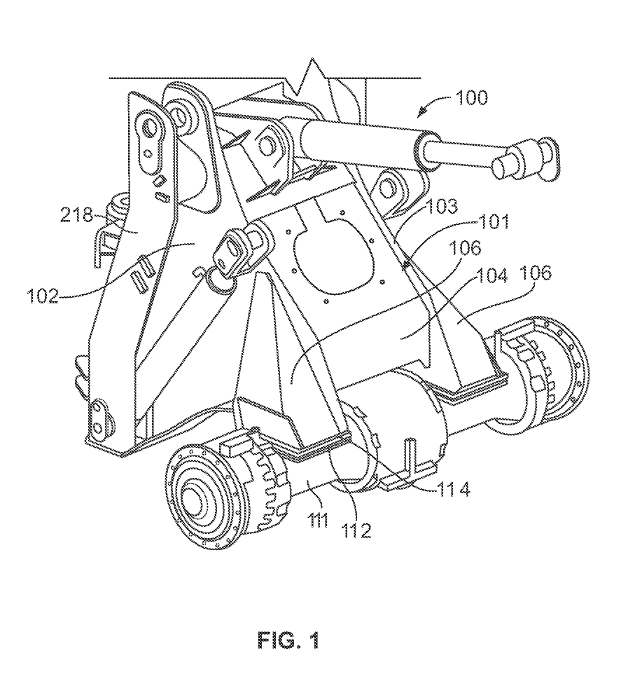

Referring now to the drawings, and with specific reference to FIG. 1, there is shown a frame assembly constructed in accordance with the present disclosure and generally referred to by reference numeral 100. While the following detailed description and drawings are made with reference to a frame for a NEEF of a wheel loader, the teachings of this disclosure may be employed on other earth moving, construction, material handling or mining vehicles including, but not limited to, loaders utilizing articulated or unitary frames, or any other vehicle subject to large side forces and/or material or debris build-up on the axle housing.

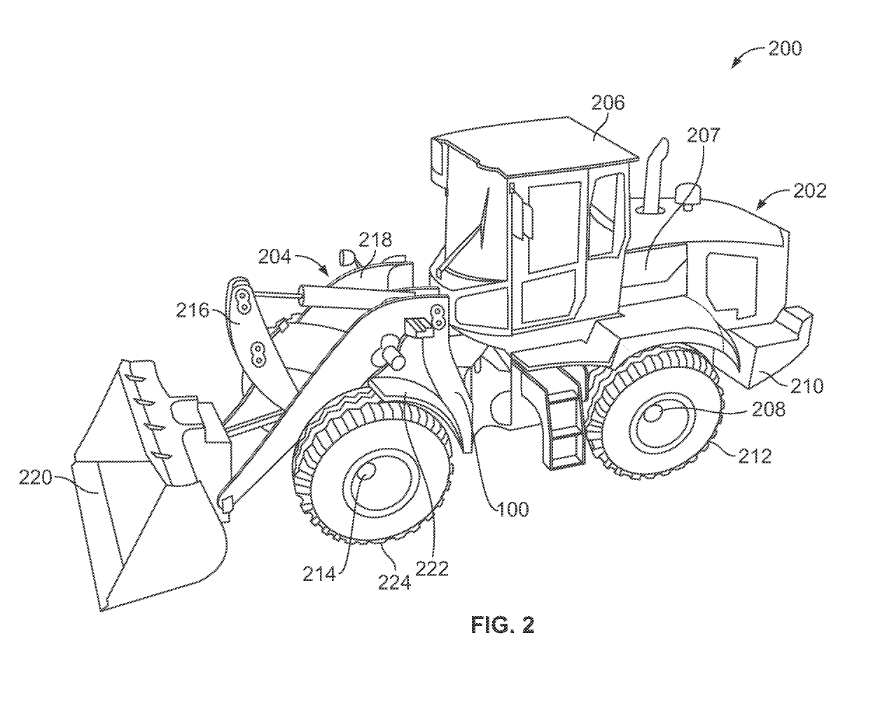

FIG. 2 illustrates one example of a machine 200 that incorporates the features of the present disclosure. The machine 200 includes a rear portion 202 and a front portion 204. The rear portion 202 may include a cab assembly 206, an engine 207, a rear axle housing assembly 208, and drive train components (not shown) mounted to a rear frame 210. Rear wheels 212 may be mounted to the rear axle housing assembly 208. The front portion 204 may include a frame assembly 100 and a front axle housing assembly 214. A boom assembly 216 and a lift arm assembly 218 may be mounted on the frame assembly 100. An implement 220 may be attached to the boom assembly 216 and to the lift arm assembly 218. The frame assembly 100 may be mounted on a fender 222. The fender 222 and front wheels 224 may be mounted on the front axle housing assembly 214.

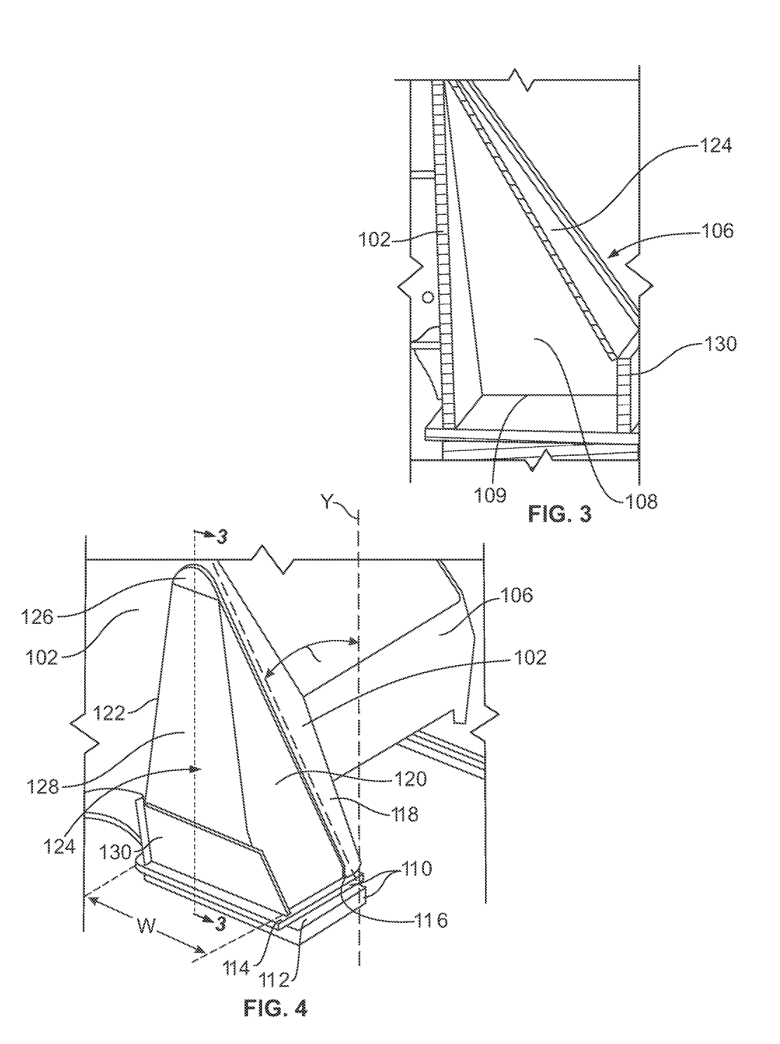

Turning now to FIG. 1, the frame assembly 100 may comprise a tower assembly 101 which includes first and second spaced apart tower walls 102, 103 separated by a middle portion 104. The frame may further comprise a foot 106 mounted to a tower wall 102, 103. The foot 106 may be welded or fixedly secured to the tower wall 102, 103. In one embodiment, a foot 106 is joined to each of the tower walls 102, 103. The foot may cover a continuous portion of the tower wall 102, 103. As shown in FIG. 3, each foot 106 may be hollow and may, together with each tower wall 102, 103, define a cavity 108 having a mouth 109. In such an embodiment, each tower wall 102, 103 forms one side of the cavity 108.

The frame assembly 100 may be mounted directly or indirectly on a base 110. The base may be an axle housing 111 of a vehicle 200. In one embodiment where the frame assembly 100 is mounted on top of the axle housing 111, each foot 106, specifically the mouth 108 of each foot 106, may be disposed on an axle pad 112 on the top of the axle housing 111. In other embodiments, a fender 114 or other foundation member may be the base 110 and may be disposed between each foot 106 and the axle housing 111 or axle housing pad 112. The axle housing 111 is part of the axle housing assembly 214 seen in FIG. 2.

Each tower wall 102, 103 may be generally planar in shape and may have a bottom edge 116 and a leading edge 118. The bottom edge 116 is proximal to the axle housing 111. The leading edge 118 is proximal to the middle portion 104 and generally faces in a direction toward the implement 220. In an embodiment, a foot 106 may be disposed on each tower wall 102, 103 above the axle housing 111 such that each foot 106 is proximal to the bottom edge 116 and proximal to the leading edge 118 of each tower wall 102, 103. In yet other embodiments, more than one foot 106 may be joined to each tower wall 102, 103 and each additional foot 106 on each tower wall 102, 103 may be positioned proximal to the bottom edge 116 of each tower wall 102, 103.

FIG. 4 is an enlarged view of the foot 106 mounted directly on a fender 114 that is mounted on an axle pad 112 (of an axle housing 111, not shown). Each foot 106 may be comprised of a front member 120, a rear member 122 disposed opposite to the front member 120, and a side member 124. Each such member may be fixedly secured together. In one embodiment, these members 120, 122 and 124 may be welded together. In an embodiment, the bottom of the foot 106 may be wider than the top of the foot 106 and the shape of the foot 106 may generally taper from the mouth 109 (at the bottom) to the top of the foot 106.

The front member 120 of the foot 106 may be generally slanted and, in some embodiments, generally planar in shape. The front member 120 of the foot may be disposed on the tower wall such that it is oriented to generally follow the orientation of the leading edge 118 of the tower wall 102, 103 as it tapers or slopes from the bottom of the tower wall 102, 103 to the top of the tower wall 102, 103. The front member 120 may be disposed on the tower wall 102, 103 so that it substantially forms an angle β with an axis Y in a vertical plane. In an embodiment, the angle β may be in a range of about 30° to about 65°, plus or minus 10% deviation. In another embodiment, the deviation may be plus or minus 20%, or about 24° to about 78°. In yet another embodiment, the deviation may be plus or minus 30%.

The rear member 122 of the foot 106 may be generally slanted or perpendicular to the base 110, and in some embodiments, generally planar in shape.

The side member 124 may be disposed between the front and rear members 120, 122 and includes a generally inclined body portion 128. The side member 124 may also include a tab 126. The tab 126 may be disposed near the top of the foot 106 above the inclined body portion 128 and may be vertical and generally planar in shape. The tab 126 may be joined onto the tower wall 102, 103. If the side member 124 does not include a tab 126, part of the inclined body portion 128 may be joined onto the tower wall 102, 103 to help affix the foot 106 to the tower wall 102, 103. The inclined body portion 128 may be generally curved or generally planar in shape.

While in some embodiments, the inclined body portion 128 may extend from the tab 126 to the base 110, in other embodiments, the side member 124 may include a bottom wall 130 between the inclined body portion 128 and the base 110. The bottom wall 130 may be attached to and disposed below the inclined body portion 128.

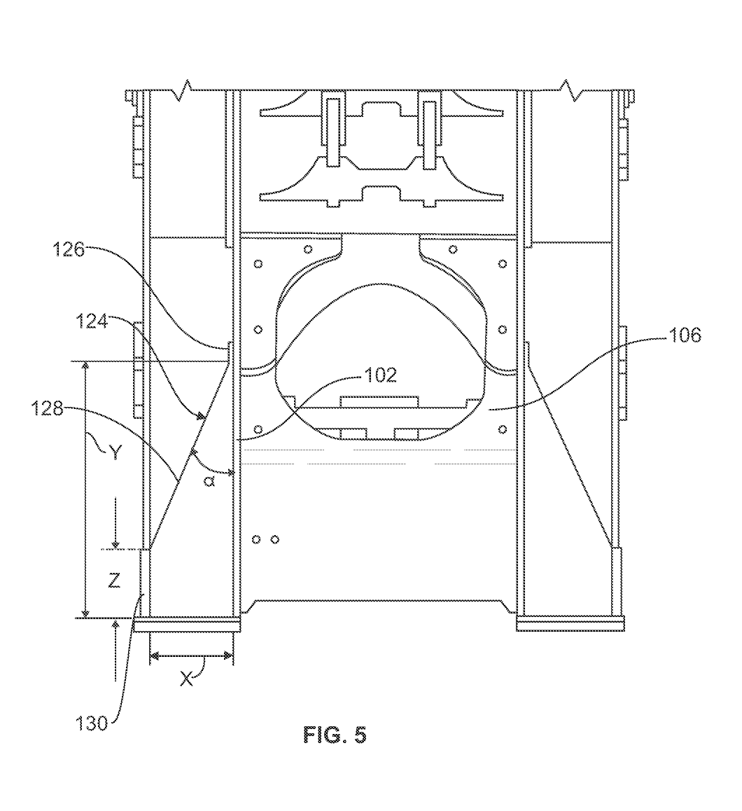

FIG. 5 illustrates relative aspects of the elements of the foot 106. In particular FIG. 5 illustrates the vertical height Z of the bottom wall 130 from the base 110, the vertical height Y of the foot as measured from the top of the inclined body portion 128 to the base 110 (upon which the mouth 109 directly contacts), and the depth X as measured from the outer surface of the tower wall 102, 103 (at the bottom edge 116) to the intersection of the inclined body portion 128 of the foot 106, the bottom wall 130, or, if there is no bottom wall 130, with the base 110. The width W of the foot is measured at the mouth 109 from the front member 120 to the rear member 122, may be seen in FIG. 4.

As illustrated in FIG. 5, the height Z of the bottom wall 130 may be less than the height Y of the foot 106. The side member 124 may be disposed to form an angle α with the tower wall 102, 103. The angle α may be in the range of about 15° to about 45°, plus or minus 10% deviation. In another embodiment, the deviation may be plus or minus 20%, or about 12° to about 54°. In yet another embodiment, the deviation may be plus or minus 30%.

It has been determined that a frame assembly 100 including a foot 106 structure having a tast factor in the range of about 1.26 to about 4.74 demonstrates increased structural strength under severe side loads along with superior shedding throughput of debris. In testing, the ability to withstand such side loads increased by about 30-50% for foot structures with a tast factor in the above range. In addition, shedding throughput, the flow of material debris away from the axle assembly to the ground, was also maximized for foot structures with a tast factor in the above range. The tast factor is represented by the following formula:

tast=Y/X+tan α

A method of manufacturing a frame assembly 100 for a vehicle 200 is also disclosed. The method may comprise forming a foot 106 comprising a slanted front member 120 fixedly joined to a side member 124 having an inclined body portion 128, providing a tower assembly 101 that include first and second spaced apart tower walls 102, 103 separated by a middle portion 104, positioning the foot 106 against the first tower wall 102 to define a cavity 108 between the tower wall 102 and the foot 106, and fixedly securing the foot 106 to the first tower wall 102 so that the inclined body portion 128 substantially forms an angle α in the range of about 15° to about 45° and the slanted front member 120 generally follows the contour of a sloped leading front edge 118 of the first tower wall 102.

### INDUSTRIAL APPLICABILITY

In general, the present disclosure may find applicability in reinforcing and improving the structural integrity of many machines, particularly earth moving vehicles. The frame assembly may comprise first and second spaced apart tower walls separated by a middle portion and a foot joined to the first tower wall. The foot may comprise a slanted front member, a rear member disposed opposite to the front member, and a side member. The side member may be disposed between the front and rear members and may be oriented to form an angle α with the first tower wall.

The frame assembly disclosed herein increases the ability of a vehicle to withstand side and other stress forces, inhibits the buildup of material and debris around the axle housing and increases the ability of the vehicle to shed material and debris from the area around the axle housing.

These features may be particularly beneficial to wheel loaders and other earth moving, construction, mining or material handling vehicles that experience large side forces and accumulation of debris during operation.

What is claimed is:

1. A frame assembly for a vehicle, the frame assembly comprising:
first and second spaced apart tower walls separated by a middle portion; and
a foot joined to the first tower wall, the foot and the first tower wall defining a cavity having a mouth, the foot comprising:
a slanted front member;
a rear member disposed opposite to the front member; and
a side member including a substantially vertical tab and an inclined body portion, the tab disposed above the inclined body portion and joined onto the first tower wall, the side member disposed between the front and rear members and oriented to form an angle α with the first tower wall.

2. The frame assembly of claim 1, wherein the angle α is in the range of about 15° to about 45°.

3. The frame assembly of claim 1, wherein a width of the foot generally tapers from the mouth to the top of the foot.

4. The frame assembly of claim 1, wherein the first tower wall has a bottom edge and the foot is disposed proximal to the bottom edge of the first tower wall.

5. The frame assembly of claim 4, wherein the first tower wall has a leading edge and the foot is disposed proximal to the leading edge of the first tower wall.

6. The frame assembly of claim 5, wherein the front member is oriented to generally follow the orientation of the leading edge of the first tower wall.

7. The frame assembly of claim 1, the side member further including a bottom wall disposed below the inclined body portion.

8. The frame assembly of claim 1, wherein the first tower wall extends continuously across the foot.

9. The frame assembly of claim 1, wherein the front and rear members and the inclined body portion of the foot are each generally planar.

10. The frame assembly of claim 1, wherein the front member substantially forms an angle β with a vertical plane.

11. The frame assembly of claim 10, wherein the angle β is in the range of about 30° to about 65°.

12. A frame assembly for a vehicle having an axle, the frame assembly comprising:
first and second spaced apart tower walls separated by a middle portion; and
a hollow foot joined to the first tower wall, the foot having a tast factor in the range of about 1.26 to about 4.74, the foot comprising:
a slanted front member;
a rear member disposed opposite to the front member; and
a side member having an inclined body portion, the side member disposed between the front and rear members and oriented to form an angle α with the first tower wall.

13. The frame assembly of claim 12, wherein the first tower wall has a bottom edge and the foot is disposed above the axle of the vehicle and proximal to the bottom edge of the first tower wall.

14. The frame assembly of claim 13, wherein the first tower wall has a leading edge and the foot is disposed proximal to the leading edge of the first tower wall.

15. The frame assembly of claim 12, the side member further comprising a bottom wall disposed below the inclined body portion.

16. The frame assembly of claim 12, wherein the first tower wall extends continuously across the foot.

17. The frame assembly of claim 12, wherein the front and rear members and the inclined body portion of the foot are each generally planar.

18. The frame assembly of claim 12, wherein the front member substantially forms an angle β with a vertical plane.

19. The frame assembly of claim 18, wherein the angle β is in the range of about 30° to about 65°.

20. A method of manufacturing a frame assembly for a vehicle, the method comprising:
forming a foot comprising a slanted front member fixedly joined to a side member having an inclined body portion;
providing a tower assembly, the tower assembly including first and second spaced apart tower walls separated by a middle portion, each tower wall including a sloped leading edge;
positioning the foot against the first tower wall to define a cavity between the tower wall and the foot; and
fixedly securing the foot to the first tower wall so that the inclined body portion substantially forms an angle α in the range of about 15° to about 45° and the slanted front member generally follows the contour of the leading front edge of the first tower wall.
